(19) United States
(12) Patent Application Publication
(10) Pub. No.: US 2005/0015320 A1
(43) Pub. Date: Jan. 20, 2005

(54) Method and system for automatic portfolio monitoring

(75) Inventors: Amy M. Hayenhjelm, Livingston, NJ (US); Barbara L. Schmelz, Glen Gardner, NJ (US); Keith Edward Gastauer, Hoboken, NJ (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Dun & Bradstreet, Inc.

(21) Appl. No.: 10/793,338

(22) Filed: Mar. 4, 2004

Related U.S. Application Data
(60) Provisional application No. 60/458,351, filed on Mar. 28, 2003.

(51) Int. Cl. G06F 17/60

(52) U.S. Cl. 705/36

(57) ABSTRACT

A portfolio monitoring and alerting service is available over the web that is user-friendly and easy to maintain. This service allows each user to monitor a portfolio of accounts on customers and suppliers containing business and financial information and observe changes to individual accounts within the portfolio, to manage the portfolio by adding or deleting accounts, to receive notice of and view alerts, and to receive notices for report renewal.

### CROSS-REFERENCE TO RELATED APPLICATIONS

The present application claims the benefit of provisional application Ser. No. 60/458351, entitled “Method and System for Automatic Portfolio Monitoring”, filed Mar. 28, 2003, attorney docket no. 384.7776USP.

### BACKGROUND OF THE INVENTION

1. Field of the Invention

The present disclosure generally relates to providing business and financial information. In particular, the present disclosure relates to portfolio monitoring.

2. Description of Related Art

Continuous monitoring is a subscription service on a desktop computing device or on a website where changes to business and/or financial reports are monitored and subscribers receive notifications of changes.

Alert service is a subscription service on a desktop computing device, where a subscriber's accounts (a/k/a cases) are monitored and alerts are provided periodically. In other embodiments, a subscriber selects accounts to monitor, selects which data elements to monitor for each account, and selects a frequency of notification.

Web alerts is a process of alerting users on a website that a change has occurred on a previously purchased business and/or financial report without providing what information in the report changed.

An annual report update (ARU) is a service that periodically reminds a previous business and/or financial report purchaser of the age of the report and optionally provides a discount for renewing the report.

There is a need for a portfolio monitoring and alerting service available over the web that is user-friendly and easy to maintain. The present invention would allow each user to monitor a portfolio of accounts and observe changes to individual accounts within the portfolio, to manage the portfolio by adding or deleting accounts, to receive notice of and view alerts, and to receive notices for report renewal.

### BRIEF SUMMARY OF THE INVENTION

The present disclosure is directed to a system and method for portfolio monitoring that meets these and other needs.

One aspect of the present disclosure is a system for portfolio monitoring comprising a website, an application server, a database, and a communications component. The website is for providing access to a portfolio of accounts. The application server is for processing requests for managing the portfolio of accounts. The database is for storing information associated with the portfolio of accounts. The communications component is for notification of changes to information association with the portfolio of accounts. In some embodiments, the system further comprises a billing system for receiving billing information from the application server. The application server includes logic for retrieving the portfolio of accounts, retrieving information for each account, receiving orders, receiving registration information, and providing billing information. In some embodiments, the system further comprises a session database. In some embodiments, the system further comprises a archive database for storing information associated with the accounts. In some embodiments, the system further comprises a subscription database for storing information associated with subscriptions to monitoring service. Each account includes business and financial information about a customer or supplier. The requests adding an account, deleting an account, requesting monitoring service for an account, and requesting a report for an account. The notification is performed according to user-defined preferences.

Another aspect is a method for portfolio monitoring. Access is provided to a portfolio of accounts on a website. Requests are processed for managing the portfolio of accounts. Information associated with the portfolio of accounts is stored. Notification of changes to the portfolio of accounts is provided. The information is business and financial information. In some embodiments, a report on one account in the portfolio of accounts is provided. In some embodiments, a list of each notification of changes is provided. The notification of changes is performed according to user-defined preferences. In some embodiments, the requests are: order a report, view portfolio, view notification, subscribe to monitoring service, add account, delete account, receive notification, update preferences, and view report.

Another aspect is a computer-readable medium having executable instructions stored thereon to perform a method for portfolio monitoring. A profile having information associated with a user account is provided on a website. A portfolio of accounts is provided on the website. Each account in the portfolio of accounts comprises business and financial information associated with at least one business entitiy. Notices of changes to the portfolio of accounts is provided. In some embodiments, the profile comprises account information, user preferences, and online usage statements. In some embodiments, each of the notices of changes comprises an indication of a type of change to the portfolio of accounts. In some embodiments, the indication is classified according to a degree of change. In some embodiments, facilities are provided to provide the following functions: deleting selected notices, printing notices, requesting additional information about one of the notices, and ordering a report associated with one of the notices. In some embodiments, providing the portfolio of accounts comprises providing at least one report associated with the portfolio of accounts. In some embodiments, the following functions are provided: viewing all reports, viewing investigated reports, viewing archived reports, viewing selected reports, and deleting reports. In some embodiments, providing the portfolio of accounts comprises providing data associated with the portfolio of accounts. In some embodiments, providing the portfolio of accounts comprises providing monitoring information associated with an account in the portfolio of accounts. In some embodiments, providing the portfolio of accounts comprises filtering information in the portfolio of accounts.

### BRIEF DESCRIPTION OF THE DRAWINGS

These and other features, aspects, and advantages of the present disclosure will become better understood with regard to the following description, appended claims and accompanying drawings where:

FIG. 1 is a block diagram of an example system for portfolio monitoring;

FIG. 2 is a screenshot of an example user interface for portfolio monitoring;

FIG. 3 is a screenshot of an example user interface for selecting a profile feature;

FIG. 4 is a screenshot of an example user interface for displaying account information;

FIG. 5 is a screenshot of an example user interface for editing user preferences;

FIG. 6 is a screenshot of an example user interface for online usage statements;

FIG. 7 is a screenshot of an example user interface for displaying usage statements;

FIG. 8 is a screenshot of an example user interface for selecting a notices feature;

FIG. 9 is a screenshot of an example user interface for monitoring notices;

FIG. 10 is a screenshot of an example user interface for monitoring a particular kind of notice;

FIG. 11 is a screenshot of an example user interface for monitoring a particular entity;

FIG. 12 is a screenshot of an example user interface for displaying monitoring information about a particular entity;

FIG. 13 is a screenshot of an example user interface for monitoring a particular kind of notice;

FIG. 14 is a screenshot of an example user interface for selecting a portfolio feature;

FIG. 15 is a screenshot of an example user interface for selecting a particular kind of portfolio feature;

FIG. 16 is a screenshot of an example user interface for displaying reports;

FIG. 17 is a screenshot of an example user interface for filtering a search;

FIG. 18 is a screenshot of an example user interface for a viewing monitoring information;

FIG. 19 is a screenshot of an example user interface for displaying monitoring information;

FIG. 20 is a screenshot of an example user interface for ordering data products;

FIG. 21 is a screenshot of an example user interface for monitoring service renewal;

FIG. 22 is a screenshot of an example user interface for an alerting feature;

FIG. 23 is a block diagram of an example system for portfolio monitoring;

FIG. 24 is a block diagram of a user interface layout for portfolio monitoring; and

FIG. 25 is a block diagram of an example system for portfolio monitoring.

### DETAILED DESCRIPTION OF THE INVENTION

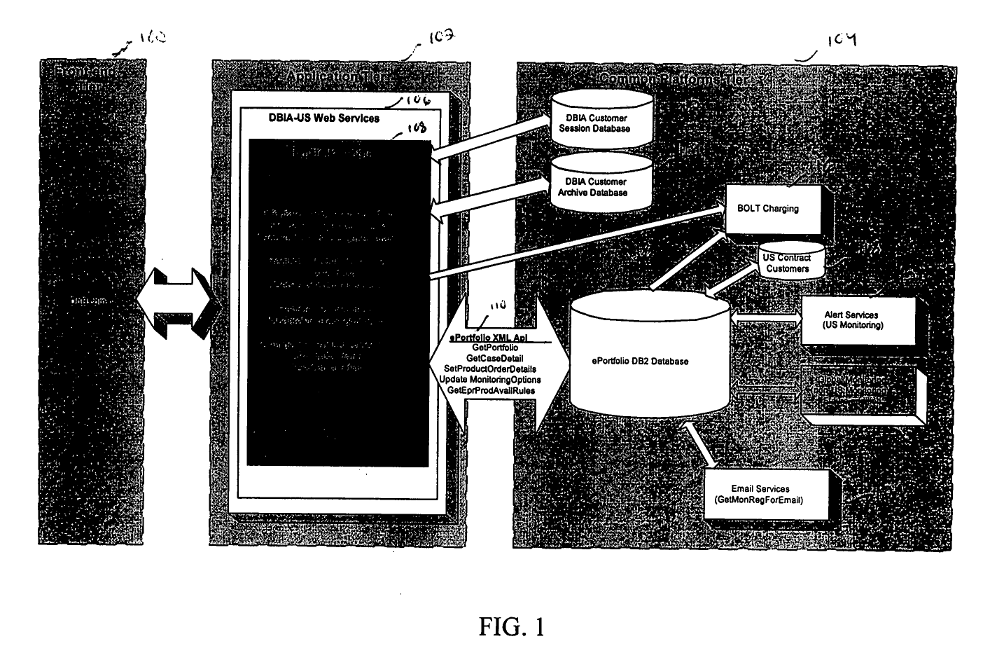

FIG. 1 shows an example system for portfolio monitoring. This example system is implemented with a 3-tier application model that includes a front-end tier 100, an application tier 102, and a common platforms tier 104. However, the portfolio monitoring system is implementable on many different systems in many different ways.

The front-end tier 100 provides the presentation interface for the portfolio monitoring service.

The application tier 102 has a web services component 106 and a portfolio logic component 108, which processes user requests. The portfolio logic component 108 integrates a product archive list with registration data, retrieves portfolios and details about the accounts in the portfolios, registers product orders, registers monitoring service, and performs billing functions. The application tier 102 communicates via an extensible markup language (XML) application program interface (API) 110 with the common platforms tier 104.

The common platforms tier 104 manages data related to the portfolio monitoring service for both domestic and foreign data. The common platforms tier 104 includes a customer session database 112, a customer archive database 114, a billing system 116, a U.S. contract customers database 118, an alert services system 120, a global monitoring system 122, an email services system 124, and a portfolio database 126.

Portfolio monitoring enables users to observe changes in an account portfolio and receive alerts on a website. When a user purchases a report on a company, the user enrolls the company in the portfolio. The user has the option to delete records from the portfolio if the user no longer wishes to view them. The portfolio is displayed with change indicators that indicate when significant changes occur and accounts that have monitoring service are flagged. Portfolio monitoring service includes website alerts, viewing the portfolio, and monitoring subscriptions.

The portfolio monitoring service includes a portfolio view on a website displaying the portfolio at a glance. In this way, the user is able to view all the reports in the portfolio, delete reports, view paydex score changes, order monitoring services, and understand which accounts are monitored. There are various types of monitoring services, including continuous monitoring, alert services inquiry, and traditional alert services. The user receives web alerts, has access to links to obtain web alerts, and has access to links to obtain monitoring alerts with each type of service.

Web alerts are sent to a user when a change has occurred in an account that is being monitored. Some examples of changes that trigger alerts are: significant suit, lien, or judgment, bankruptcy, burglary, embezzlement, businesses sold, businesses merged, businesses acquired, control change, change of chief executive, credit rating change, paydex change, credit score change, and stress score change.

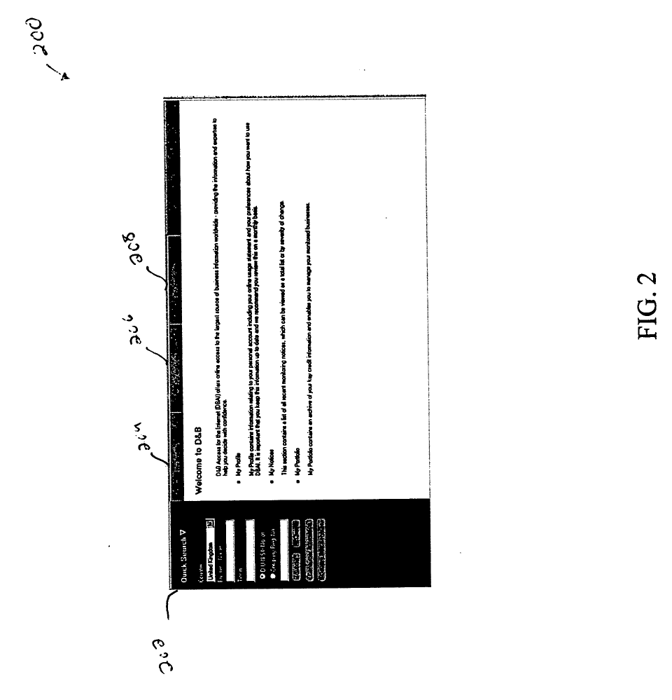

FIG. 2 shows an example user interface 200 for portfolio monitoring. The example user interface 200 includes a search feature 202 and tabs for access the user's profile 204, notices 206, and portfolio 208. The search feature 202 enables searching by country, entity name, town, unique corporate identifier, such as a DUNS Number, and company registration number. The search feature 202 provides consumer information and country risk information. The profile 204 has information relating to the user's account, including an online usage statement and preferences. The notices 206 has a list of recent monitoring notices that are viewable as a total list or by severity of change. The portfolio 208 has an archive of the user's credit information for managing monitored entities.

Research and usability tests revealed that the portfolio needs to be presented to the user early on in a session in order to draw attention to it. Preferably, the portfolio view is presented upon successful login with links to the portfolio, alerts, and reports. A portfolio snapshot, which is a reduced version of the portfolio view, is presented where the number of cases is limited, such as the top 25. A full portfolio view is available from a link on the page after login.

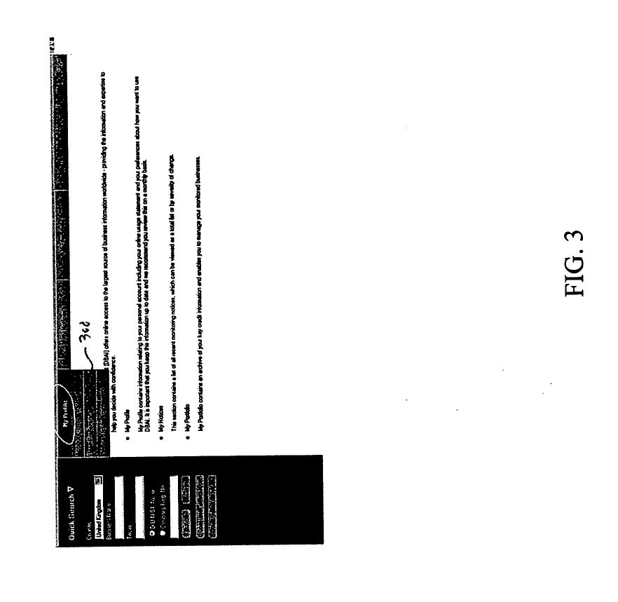

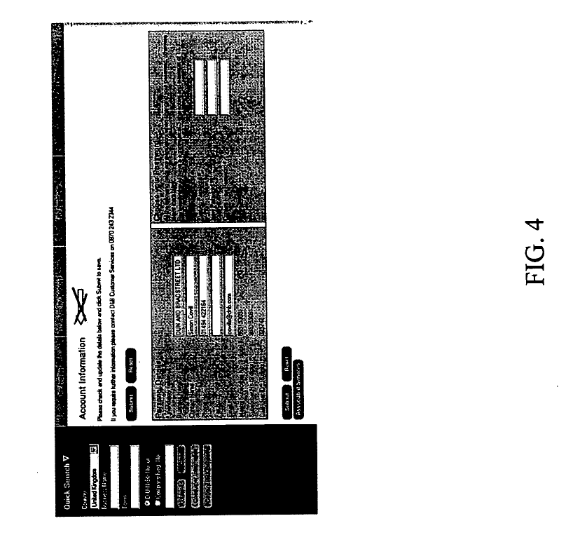

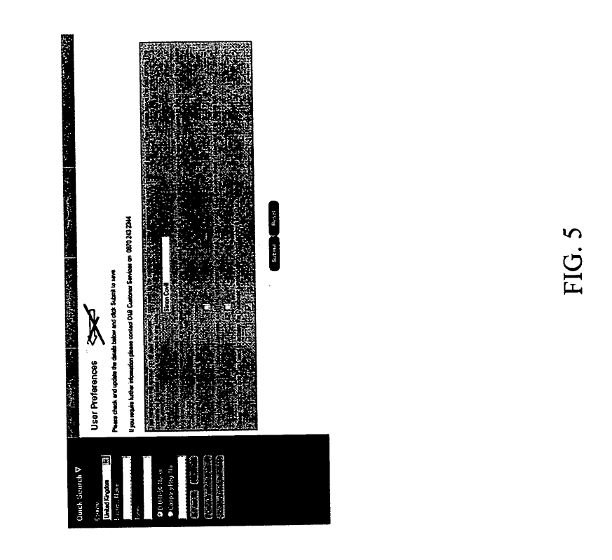

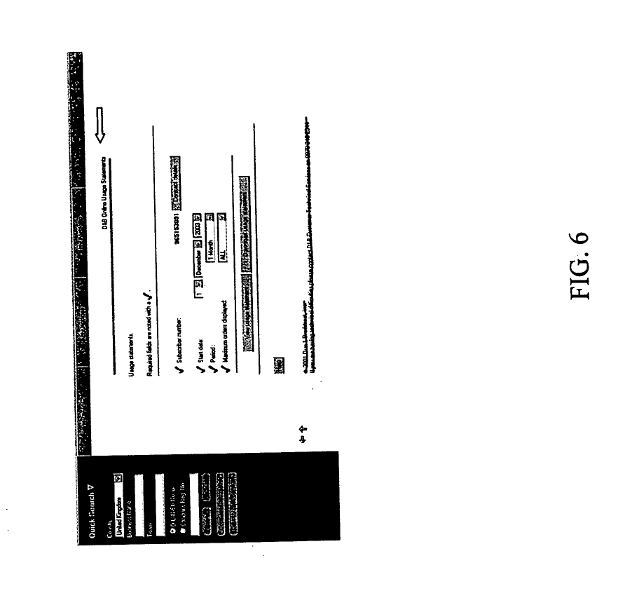

FIG. 3 shows how the user selects a profile feature from a list 300 of account information, user preferences, and online usage statements. If the user selects account information, then FIG. 4 is presented. If the user selects user preferences, then FIG. 5 is presented. If the user selects online usage statements, then FIG. 6 is presented.

FIG. 4 presents editable account information. In this example, the user is prompted to enter or reset personal details and a password or to select associated services.

FIG. 5 presents editable user preferences. In this example, the user is prompted to enter a default reference to be associated with inquiries, to select whether to receive email notices or online notices, select an email format, and whether to access database functionality via web features for accessing reports and data.

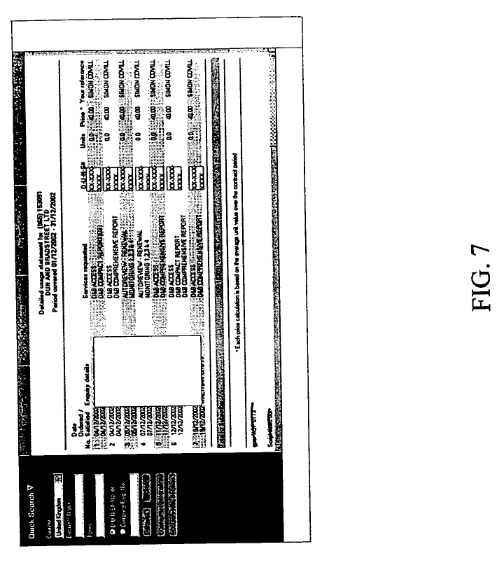

FIG. 6 presents options for online usage statements. In this example, the user is prompted to enter information, to view contract details, or to view or download a usage statement. If the user selects viewing the usage statement, FIG. 7 is presented.

FIG. 7 presents a usage statement. In this example, information about inquiries, such as date, service, unique corporate identifier, units, price, and associated reference are presented.

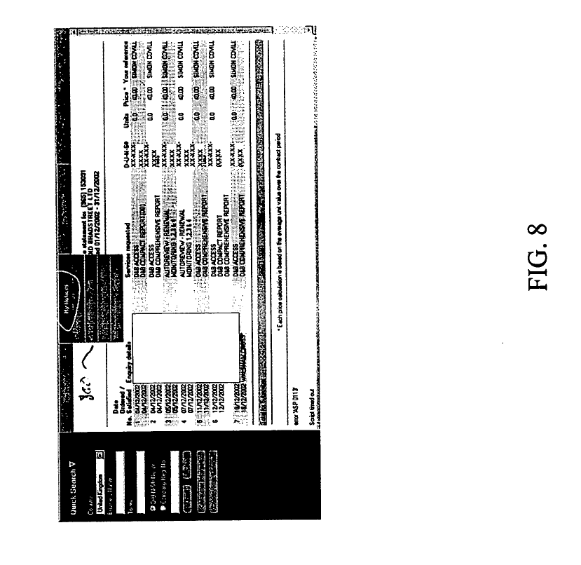

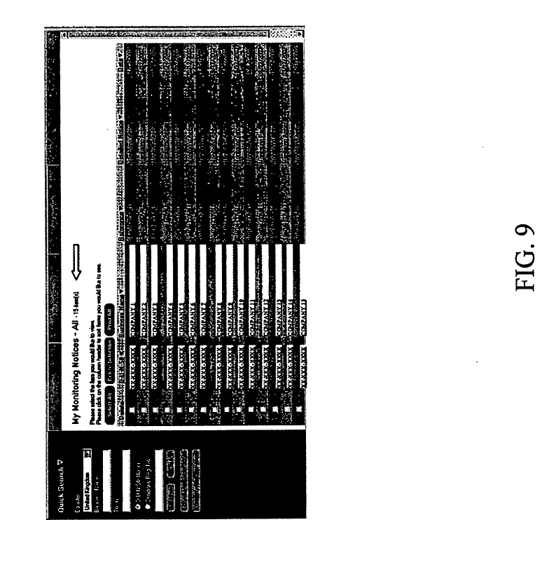

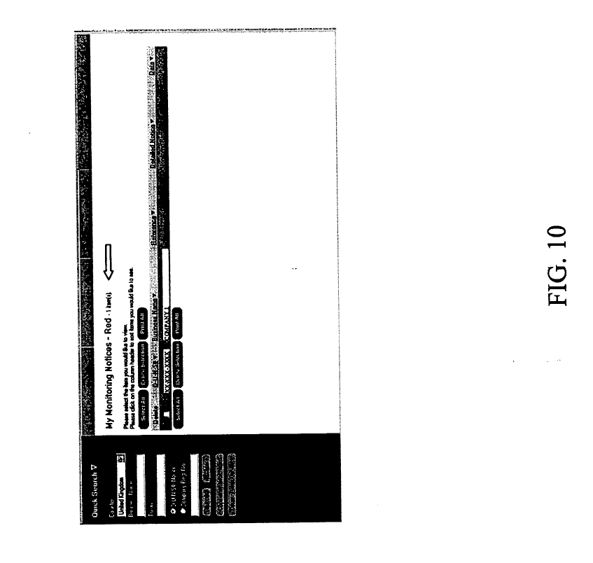

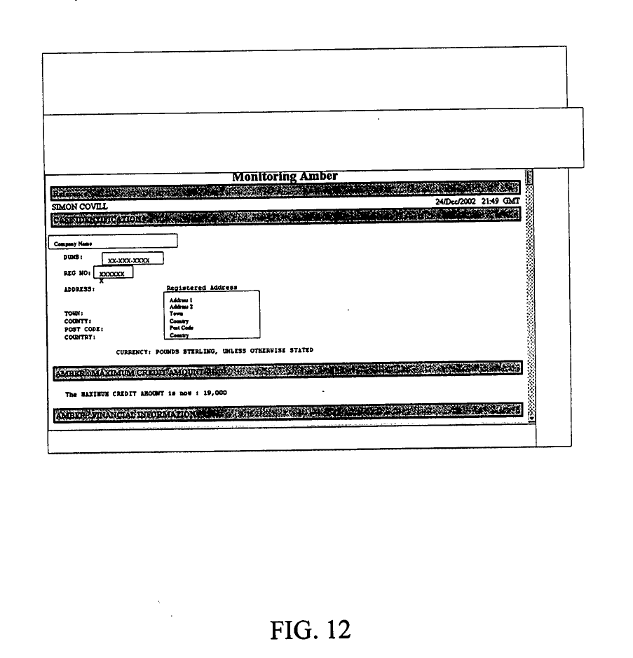

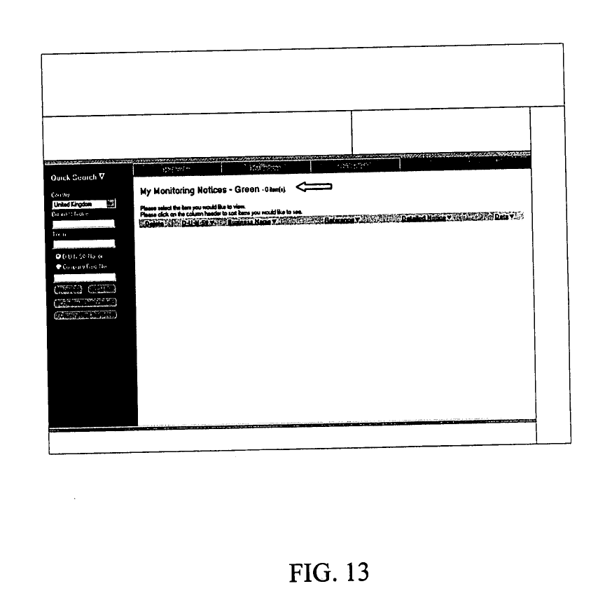

FIG. 8 shows how the user selects a notices feature from a list 800 of all changes, critical changes (red), informative changes (amber), and positive changes (green). If the user selects all changes, then FIG. 9 is presented. If the user selects critical changes (red), then FIG. 10 is presented. If the user selects informative changes (amber), then FIG. 12 is presented. If the user selects positive changes (green), then FIG. 13 is presented.

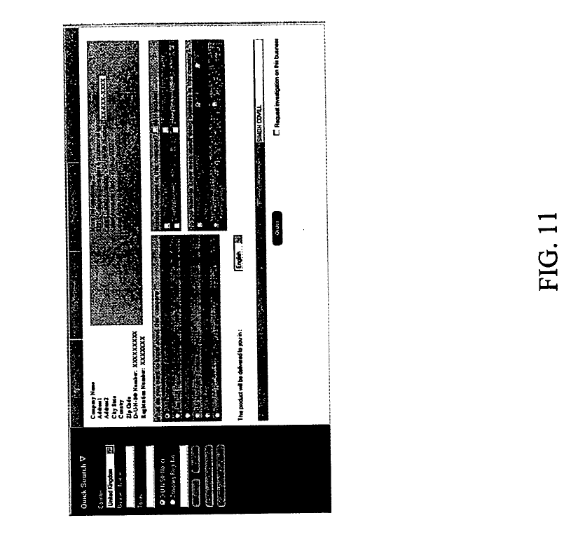

FIG. 9 presents all the changes for the notices associated with the user's account. In this example, the user is prompted to select all, delete selection, and print all. Information about the notices is presented, including the unique corporate identifier, the entity name, the associated reference, and date. In addition, an option to view detailed notices and the associated color (e.g., red, amber, or green) is presented. If the user selects to view detailed notices, then FIG. 11 is presented.

FIG. 10 presents the critical changes (red) for the notices associated with the user's account.

FIG. 11 presents a detailed notice associated with a particular entity. In this example, the user is prompted to view more information, such as a paydex score, to order a report or other data product, to monitor changes, and to learn more about doing business in a country. The user is prompted to select changes to monitor, such as all information, time critical data, legal or general information, rating and payment information, and the latest balance sheet. The user is prompted to select options associated with learning more about doing business in a country, such as a country risk line report or a country report. The user is prompted to select the language of the report, such as English and to enter a billing reference.

FIG. 12 presents the informative changes (amber) for the notices associated with the user's account.

FIG. 13 presents the positive changes (green) for the notices associated with the user's account.

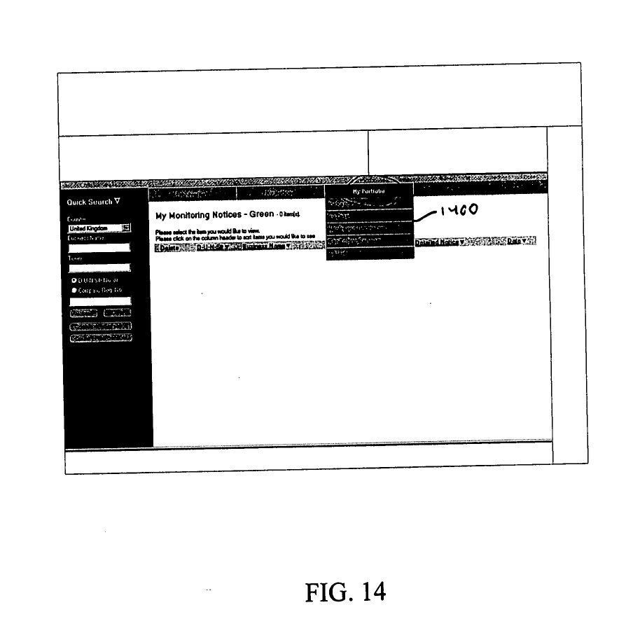

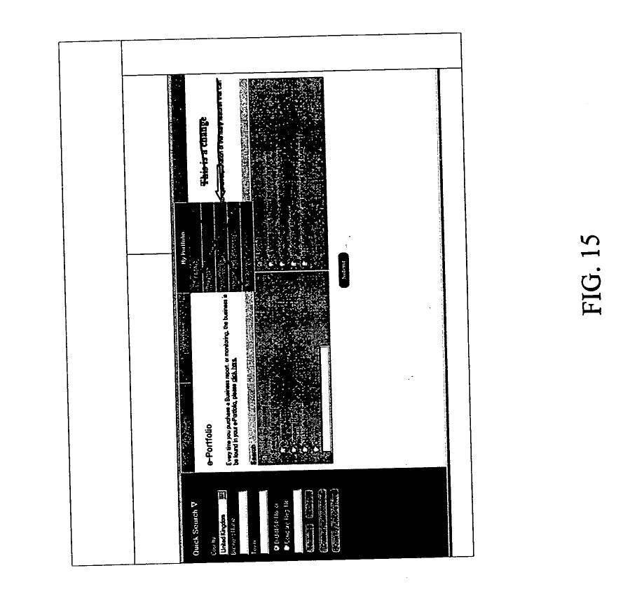

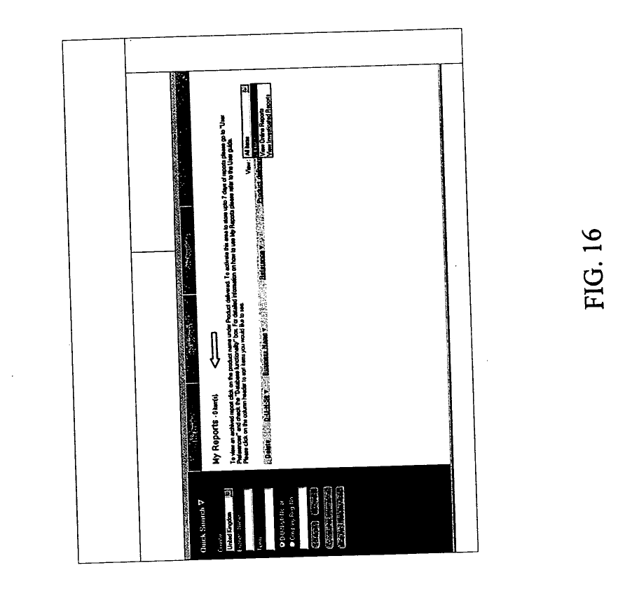

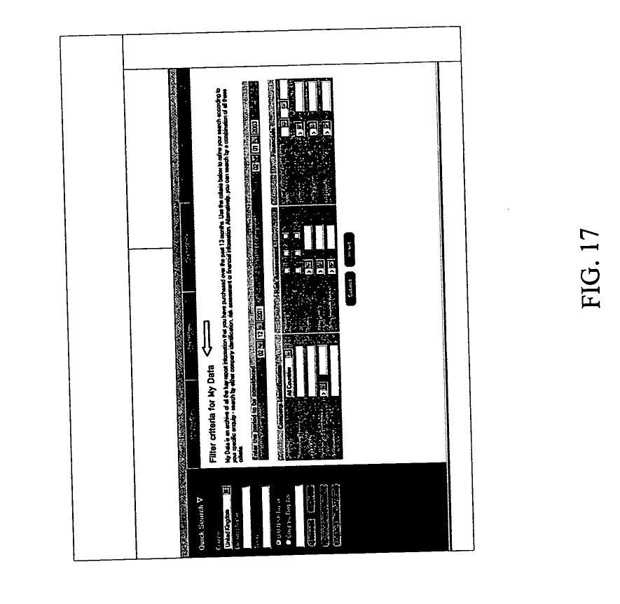

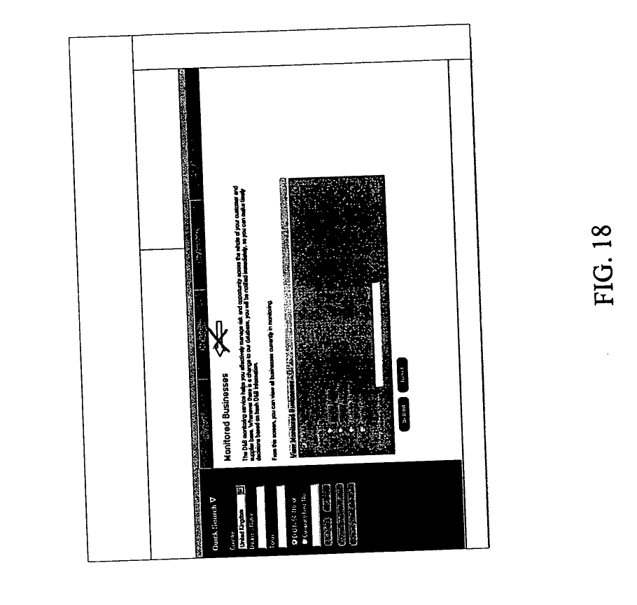

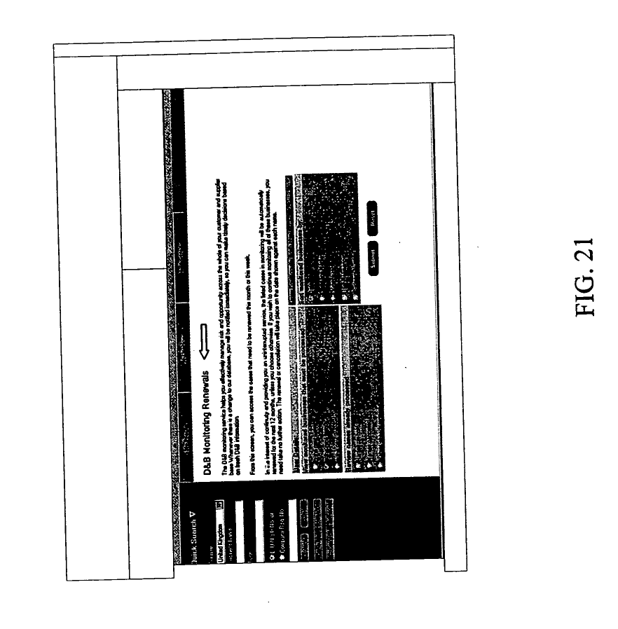

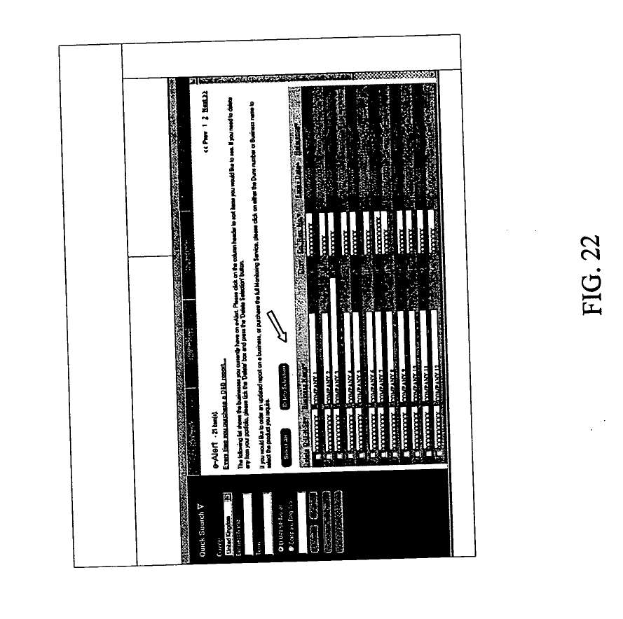

FIG. 14 shows how the user selects a portfolio feature from a list 1400 of reports associated with the user's portfolio, data associated with the user's portfolio, the user's portfolio, monitored businesses, monitoring renewals, and alert information. If the user selects their portfolio, then FIG. 15 is presented. If the user selects reports associated with their portfolio, then FIG. 16 is presented. If the user selects data associated with their portfolio, then FIG. 17 is presented. If the user selects monitored businesses, then FIG. 18 is presented. If the user selects monitoring renewals, then FIG. 21 is presented. If the user selects alert information, then FIG. 22 is presented.

FIG. 15 presents options for the user's portfolio. In this example, the user is prompted to select whether to display the complete portfolio or search by business name, company registration number, unique corporate identifier, or country and the user is prompted to select from a list of all types, full access back to view the report at any time, detailed notification of changes to a business, notification of changes, and no notice of changes to a business.

FIG. 16 presents options for the reports associated with the user's portfolio. In this example, the user is prompted to select from a list of viewing all items, viewing online reports, and viewing investigated reports. Some reports are archived according to user preferences. The user has the option of viewing archived reports. The user has the option of sorting the reports by unique corporate identifier, business name, reference, and product type. The user also has the option of deleting reports.

FIG. 17 presents data associated with the user's portfolio. In this example, the data is archived and the user is prompted to filter the data using a search by date, company identification, risk assessment, and financials.

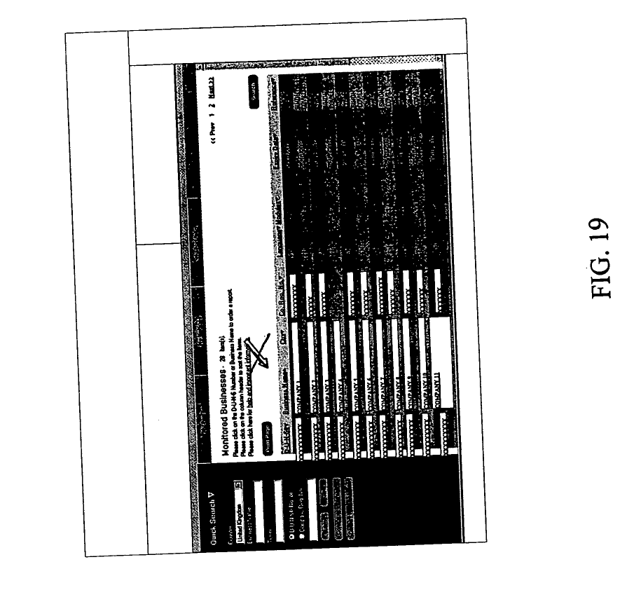

FIG. 18 presents monitored businesses associated with the user's portfolio. The monitoring service helps the user manage risk and opportunity across their suppliers and customers and notifies the user of changes so that the user can make timely decisions. In this example, the user is prompted to select from a list of viewing all of the monitored businesses, searching by business name, company registration number, unique corporate identifier, or country code, or entering another value to search by. After making a selection, FIG. 19 is presented.

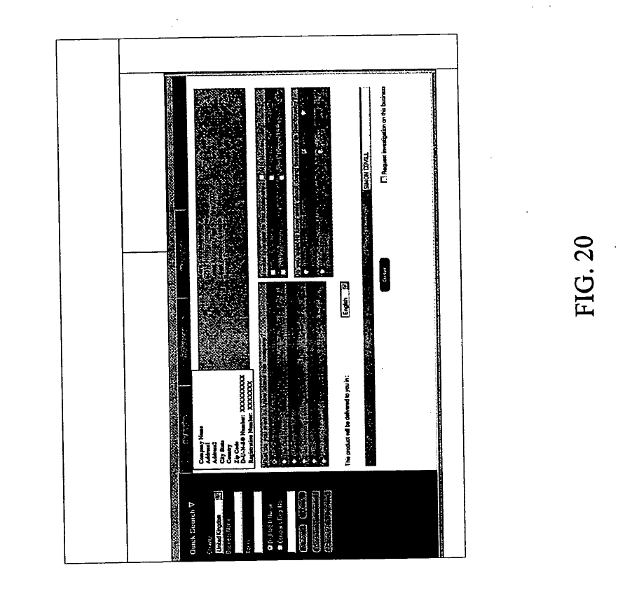

FIG. 19 presents monitoring information for selected businesses associated with the user's portfolio. In this example, the user has options to order a report, sort the monitoring information, print and search. If the user selects to order a report, then FIG. 20 is presented.

FIG. 20 presents report options associated with a particular entity. In this example, the user is prompted to view more information, to order a report or other data product, to monitor changes, and to learn more about doing business in a country.

FIG. 21 presents options for monitoring renewals. In this example, the user has the option of viewing monitored businesses that need to be processed during various time periods, reviewing names already processed with various statuses, and sorting monitored businesses by various criteria.

FIG. 22 presents alert information. In this example, alerts are displayed and the user is prompted to select from the following options: delete, sort and service and report ordering options.

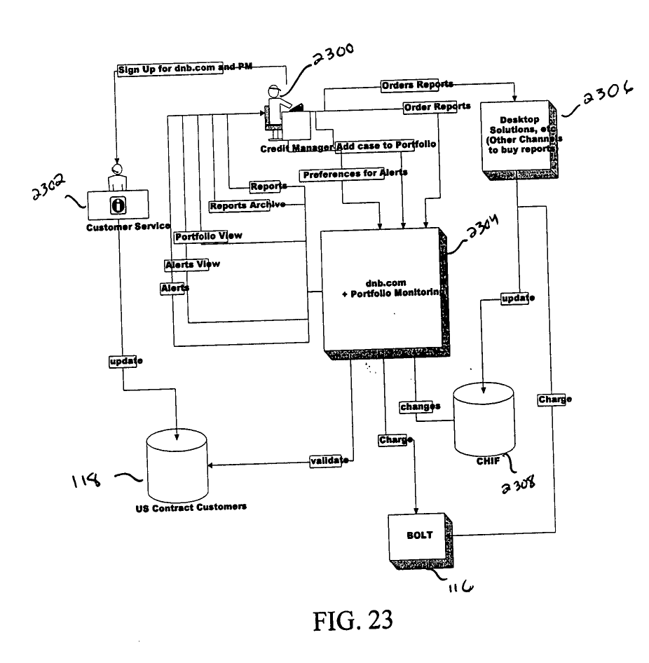

FIG. 23 shows an example system for portfolio monitoring. In this example, a credit manager 2300 signs up for website access and portfolio monitoring service through customer service 2302, which updates information in the contract customers database 118. The credit manager 2300 adds cases to a portfolio and sets preferences through the website 2304. The credit manager 2300 orders some reports through a desktop service 2306 or another channel for ordering reports and orders other reports through the website 2304. The website 2304 validates information in the contract customers database 118 and send billing information to the billing system 116 and another database 2308. The desktop service 2306 updates information in the other database 2308 and sends billing information to the billing system 116. The website 2304 provides reports, reports archives, portfolio views, alert views, and alerts to the credit manager 2300.

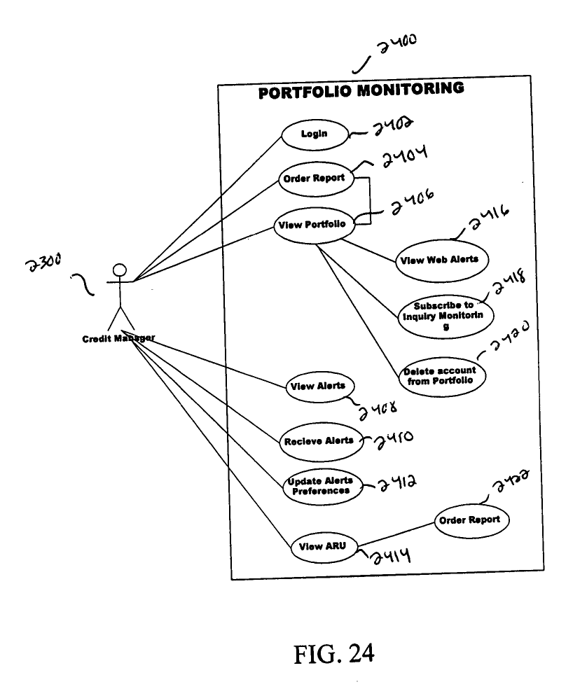

FIG. 24 shows a user interface layout for portfolio monitoring. The credit manager 2300 interacts with the portfolio monitoring system 2400 using at least the following functions: login 2402, order report 2404, view portfolio 2406, view alerts 2408, receive alerts 2410, update alerts preferences 2412, and view ARU 2414. The view portfolio function includes view web alerts 2416, subscribe to inquiry monitoring 2418, and delete account from portfolio 2420 functions. The view ARU function includes an order report function 2422.

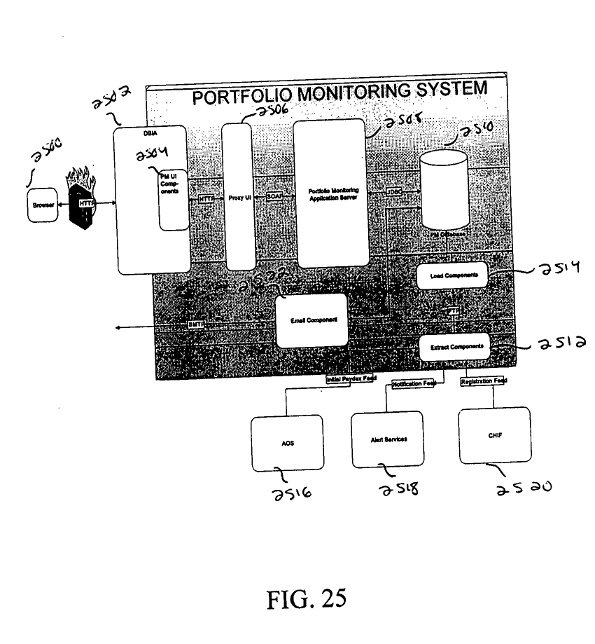

FIG. 25 shows an example system for portfolio monitoring. In this example, a browser 2500 connects to the website 2502, which has various user interface components 2504. The interface components communicate with a user interface proxy layer 2506 that, in turn, communicates with a portfolio monitoring application server 2508 that accesses a portfolio monitoring database 2510. Data for portfolio monitoring is extracted 2512 and loaded 2514 from other data sources, such as advanced office system (AOS) 2516, alert services 2518, and CHIF 2520. Information from the portfolio monitoring database 2510 is sent to users by an email component 2522. As known in the art, various technologies can be used to implement the system, such as Unix, Windows, OS/390, Smalltalk, C, shall scripts, java, XML, hypertext transfer protocol (HTTP), simple object access protocol (SOAP), java database connectivity (JDBC), simple mail transfer protocol (SMTP) and the like.

It is to be understood that the drawings and detailed description are intended to be illustrative and not restrictive. Embodiments other than the examples in the drawings and detailed description may be used. Other embodiments will be apparent to those of skill in the art upon reviewing the above description, such as voice or fax alerts. Structural, logical, and electrical changes may be made without departing from the spirit and scope of the present disclosure. Various designs using hardware, software, and firmware are contemplated by the present disclosure, even though some minor elements would need to change to better support the environments common to such systems and methods, such as various databases and programming languages. The present disclosure has applicability to fields other than business information. Therefore, the scope of the present disclosure should be determined with reference to the appended claims, along with the full scope of equivalents to which such claims are entitled.

1. A system for portfolio monitoring, comprising:
a website for providing access to a portfolio of accounts;
an application server for processing requests for managing said portfolio of accounts;
a database for storing information associated with said portfolio of accounts; and
an communications component for notification of changes to information association with said portfolio of accounts.

2. The system according to claim 1, further comprising:
a billing system for receiving billing information from said application server.

3. The system according to claim 1, wherein said application server includes logic for retrieving said portfolio of accounts, retrieving information for each account, receiving orders, receiving registration information, and providing billing information.

4. The system according to claim 1, further comprising:
a session database.

5. The system according to claim 1, further comprising:
a archive database for storing information associated with said accounts.

6. The system according to claim 1, further comprising:
a subscription database for storing information associated with subscriptions to monitoring service.

7. The system according to claim 1, wherein each account includes business and financial information about a customer or supplier.

8. The system according to claim 1, wherein said requests are at least one selected from the group consisting of: adding an account, deleting an account, requesting monitoring service for an account, and requesting a report for an account.

9. The system according to claim 1, wherein said notification is performed according to user-defined preferences.

10. A method for portfolio monitoring, comprising:
providing access to a portfolio of accounts on a website;
processing requests for managing said portfolio of accounts;
storing information associated with said portfolio of accounts; and
providing notification of changes to said portfolio of accounts.

11. The method according to claim 10, wherein said information is business and financial information.

12. The method according to claim 10, further comprising:
providing a report on one account in said portfolio of accounts.

13. The method according to claim 10, further comprising:
providing a list of each said notification of changes

14. The method according to claim 10, wherein said notification of changes is performed according to said user-defined preferences.

15. The method according to claim 10, wherein said requests are at least one selected from the group consisting of: order a report, view portfolio, view notification, subscribe to monitoring service, add account, delete account, receive notification, update preferences, and view report.

16. A computer-readable medium having executable instructions stored thereon to perform a method for portfolio monitoring, said method comprising:
providing a profile having information associated with a user account on a website;
providing a portfolio of accounts on said website, each account in said portfolio of accounts comprising business and financial information associated with at least one business entitiy; and
providing notices of changes to said portfolio of accounts.

17. The computer-readable medium according to claim 16, wherein said profile comprises at least one selected from the group consisting of: account information, user preferences, and online usage statements.

18. The computer-readable medium according to claim 17, wherein each of said notices of changes comprises an indication of a type of change to said portfolio of accounts.

19. The computer-readable medium according to claim 18, wherein said indication is classified according to a degree of change.

20. The computer-readable medium according to claim 16, further comprising:
providing facilities at least one function selected from the group consisting of: deleting selected notices, printing notices, requesting additional information about one of said notices, and ordering a report associated with one of said notices.

21. The computer-readable medium according to claim 16, wherein providing said portfolio of accounts comprises providing at least one report associated with said portfolio of accounts.

22. The computer-readable medium according to claim 21, further comprising performing a function selected from the group consisting of: viewing all reports, viewing investigated reports, viewing archived reports, viewing selected reports, and deleting reports.

23. The computer-readable medium according to claim 16, wherein providing said portfolio of accounts comprises providing data associated with said portfolio of accounts.

24. The computer-readable medium according to claim 16, wherein providing said portfolio of accounts comprises providing monitoring information associated with an account in said portfolio of accounts.

25. The computer-readable medium according to claim 16, wherein providing said portfolio of accounts comprises filtering information in said portfolio of accounts.
